(19) United States
(12) Patent Application Publication
(10) Pub. No.: US 2013/0262222 A1
(43) Pub. Date: Oct. 3, 2013

(54) CUSTOMER METRICS DRIVEN TRAVELER INFORMATION SYSTEM FOR MULTIMODAL PUBLIC TRANSPORATION SYSTEMS

(71) Applicants: George Amos Gibson, Fairport, NY (US); Marina Tharayil, Rochester, NY (US); Barry P. Mandel, Fairport, NY (US); Polykarpos Pavlidis, Evanston, IL (US)

(72) Inventors: George Amos Gibson, Fairport, NY (US); Marina Tharayil, Rochester, NY (US); Barry P. Mandel, Fairport, NY (US); Polykarpos Pavlidis, Evanston, IL (US)

(73) Assignee: Xerox Corporation, Norwalk, CT (US)

(21) Appl. No.: 13/435,419

(22) Filed: Mar. 30, 2012

(51) Int. Cl. G01C 21/00; G06Q 30/02

(52) U.S. Cl. 705/14.49; 701/400; 701/538

(57) ABSTRACT

Devices and methods provide route guidance by maintaining a plurality of user preferences, receiving a beginning location and an ending location of a trip, and receiving a trip purpose of the trip. Such devices and methods automatically generate multiple different routes between the beginning location and the ending location, automatically create a subset of less than all of the user preferences that match the trip purpose to produce purpose-specific preferences, and automatically rank the multiple different routes by ranking routes that match more of the purpose-specific preferences ahead of routes that match less of the purpose-specific preferences to produce a ranked order. Then, such devices and methods automatically output the multiple different routes in the ranked order.

### BACKGROUND

Embodiments herein generally relate to route planning systems, methods, and devices, and more particularly to utilizing the purpose of the trip to refine user preferences when selecting between multiple possible routes.

Point to point trip planning is available from many private and governmental organizations. When public transportation options are available, routes that involve mode switching are specifically enabled. Many characteristics of such trips are travel time dependant as the schedules of public transportation transfers must be coordinated. In current offerings, published schedule data is used to compute the recommended alternative routes taking into consideration such factors as time of day when the trip is scheduled to begin, and required time for arrival at the destination.

### SUMMARY

Exemplary computer implemented methods of providing route guidance herein maintain a plurality of user preferences within a non-volatile storage medium of at least one computerized device (modifications to the user preferences can be received). The user preferences can be categorized into different pre-established trip purposes. The methods herein receive a beginning location and an ending location of a trip and a trip purpose of the trip into the computerized device(s). The trip purpose can be selected from one of the pre-established trip purposes.

The methods herein automatically generate multiple different routes between the beginning location and the ending location using the computerized device(s). At least two of the multiple different routes can utilize different transportation systems (different modes of transport including private car, public transportation, walking, biking, etc.) and at least two of the multiple different routes can comprise the same single identical route that departs at different departure times.

The methods herein then automatically filter the user preferences in some manner to make the preferences be more aligned with the selected trip purpose. For example, methods herein can receive additional user input regarding the specific preferences that are to be applied to any given trip. In another example, the methods herein can (additionally or alternatively) automatically create a subset of less than all of the user preferences that match the trip purpose to produce purpose-specific preferences. Then, these methods can automatically rank the multiple different routes by ranking routes that match more of the purpose-specific preferences ahead of routes that match less of the purpose-specific preferences (to produce a ranked order of the routes). Other methods herein can (additionally or alternatively) change the weighting priority of less than all of the user preferences that match the trip purpose to produce purpose-specific weighted preferences. Such methods then automatically score each of the multiple different routes based on whether the multiple different routes match the user preferences. Thus, ones of the multiple different routes that match the purpose-specific weighted preferences receive a higher scoring relative to ones of the multiple different routes that do not match the purpose-specific weighted preferences.

Such methods herein automatically rank the multiple different routes according to the scoring or ranked order using the computerized device(s) and automatically output the multiple different routes in the ranked order from the computerized device(s).

Additionally methods herein can further automatically obtain (using the computerized device(s)) current status information of events occurring along each of the multiple different routes. Such events can comprise weather, concerts, sporting events, parades, etc. Also, other methods herein can output targeted advertizing from the computerized device(s) based on the trip purpose.

The user preferences can include (but are not limited to) for example: a preference regarding walking segments (which can be, for example, based on a weather forecast); a preference regarding amenities available at transfer stations; a preference regarding use of a specific fare payment method; a preference regarding use of stairs; a preference regarding traveling with a bicycle; a preference regarding rental of a car, bike or taxi; a preference regarding maximum number of transfers; a preference regarding a walking time and distance; a preference regarding carbon footprint; a preference regarding probability of seat availability; a preference regarding use of underground segments; a preference regarding risk on possible delays and cancellations; a preference regarding the desire to start and/or end the trip with a specific mode of transportation; etc.

Various computerized device (personal computers, personal digital assistant (PDA) units, cell phones, global positioning system (GPS) units, etc.) embodiments herein can provide route guidance. Such devices include a non-volatile storage medium operatively connected to a processor. The processor performs functions based on instructions stored in the non-volatile storage medium.

The non-volatile storage medium also maintains a plurality of user preferences. Further, a graphic user interface is operatively connected to the processor. The graphic user interface receives the beginning location, the ending location, and the trip purpose. The processor automatically generates multiple different routes between the beginning location and the ending location. The processor also automatically creates a subset of less than all of the user preferences that match the trip purpose to produce purpose-specific preferences (or purpose-specific weighted preferences, as discussed above). The processor automatically ranks the multiple different routes by ranking routes that match more of the purpose-specific (or weighted) preferences ahead of routes that match less of the preferences to produce a ranked order. Further, the graphic user interface automatically outputs the multiple different routes in the ranked order.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a chart illustrating details of embodiments herein;

FIG. 2 is a chart illustrating details of embodiments herein;

FIG. 3 is a screenshot produced by embodiments herein;

FIG. 4 is a screenshot produced by embodiments herein;

FIG. 5 is a flowchart illustrating details of embodiments herein;

FIG. 6 is a schematic diagram illustrating details of embodiments herein.

### DETAILED DESCRIPTION

As mentioned above, point to point trip planning is available from many sources. Such sources provide information on departure times for a trip. The routes may include walking segments. While this might be appropriate for some travelers, those carrying luggage or packages or those with mobility limitations might find such alternatives unacceptable.

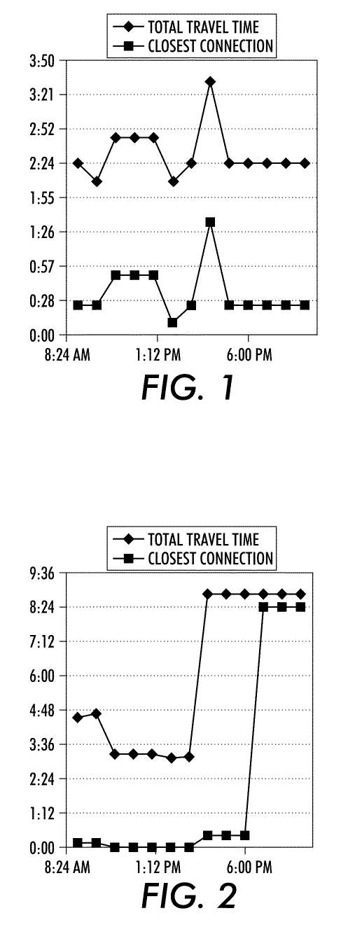

As shown in FIG. 1, during development of the systems and methods herein, it was determined that total travel time between two identical points varies (from less than 2:24 to more than 3:21) depending upon time of day (8:24 AM-6:00 PM) as shown by the upper portion of the chart shown FIG. 1. The lower portion of the chart shown in FIG. 1 represents the inter-mode transfer time (which is the time spent waiting between different legs of the journey). As is shown in FIG. 1, the variation in projected travel time is dominated by inter-mode transfer (waiting time) to which some travelers are especially sensitive.

As shown in FIG. 2, during development of the systems and methods herein, it was determined that there are large blocks of time when projected travel times are deceptively stable. This stability hides the fact that much of the total trip time (upper portion of the chart shown in FIG. 2) is waiting time (lower portion of the chart shown in FIG. 2).

The trip purpose, the time and length of the trip, and the particular route or route choices available to the individual traveler all affect whether individuals consult guidance information. Factors addressed by the systems and methods herein include user values and attitude characteristics, which are determinants of use patterns, behavioral responses, and valuation in route guidance systems.

This disclosure provides a traveler information system that integrates information on multiple modes (bus, train, plane, car, taxi, walking, biking, etc.) of public and private transportation, allowing travelers to evaluate alternate routes for point to point trips including options which combine multiple modalities of transportation. The salient characteristics of alternatives routes includes projected total travel time, number of transfers, projected waiting time at stations or hubs (including amenities at the stop), travel by foot (business nearby), fares, weather forecasts, transit capability (bike transfer, wheelchair accessibility, WiFi, fare collection system compatibility), local event information (as it effects travel times) and similar metrics.

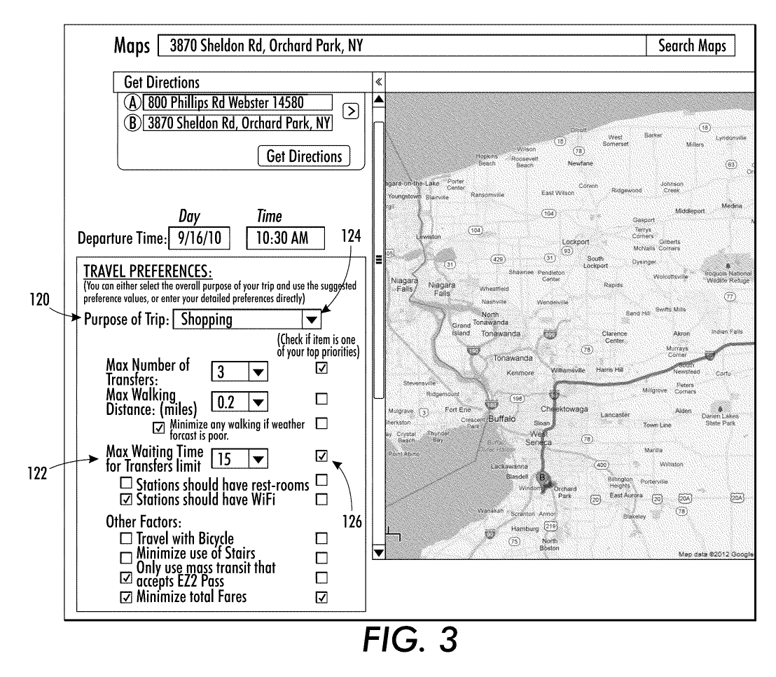

As shown in FIG. 3, the systems and methods herein provide a trip purpose input box 120, which generates a set of default parameters that can be tuned by the user. More specifically, item 124 provides a drop-down menu that can include a wide range of options such as: sightseeing; business commute; attend sporting event; visit dining establishment; custom trip purpose; etc. Depending upon the purpose selected, various user preferences 122 can be automatically selected or deselected. For example, when shopping, the system may minimize walking distance since the user may be carrying packages. Further, as shown in FIG. 3, the user can manually select or deselect user preferences 126 and can also to identify which of the preferences has a priority (high, normal, or low).

For example, user preferences may dictate a maximum acceptable waiting time for a given multi-modal transfer, a change in the use of walking segments if the weather forecast is poor, amenities desired at transfer stations, use of a specific fare payment method, use of stairs, requirements for traveling with a bicycle, rental of a car, bike or taxi, maximum number of transfers, the total walking time or distance, the total commute time, desire to minimize total costs/tolls, desire to minimize total commute time, desire to minimize carbon footprint, WiFi availability, probability for seat availability, use of underground segments, an index of risk on possible delays and cancellations, desire to start or end the trip with a given mode of transportation, etc. The systems and methods herein use knowledge of local events (concert, sporting event, parade, etc) to modify at least one of the predicted transit times for a given leg of the trip, and the recommended route or modes of transportation to be used. Further, various embodiment herein can provide targeted advertizing/promotions based on the selected trip purpose.

Thus, the selection of a trip purpose generates a corresponding set of default settings for preference parameters. These defaults can, in one option, be generated from standard travel preference survey data/studies. The parameters can also be tuned over time for a given region/season. Alternatively, the defaults can be modified by each individual user for their purposes and saved for future reference.

Therefore, with the systems and methods herein, a prospective traveler can enter the point to point travel requirements (including potentially day and/or time of day) and information about the relative importance of the travel route preferences—total travel time, total waiting time, total fare, amount of walking involved, etc. In response, a number of alternative travel routes ordered by conformance to the travelers stated preferences is provided as output to the traveler.

In cases where significant walking would ordinarily be included in route segments, alternatives (e.g. taxi) could be considered and the appropriate availability, delay and expense is added to the analysis presented to the prospective traveler. This is further augmented by adding data about the hubs where taxis are commonly readily available, and by providing available real-time location data on taxi location. Rental or other publicly available options can also be listed in cities where the options and information are publicly available.

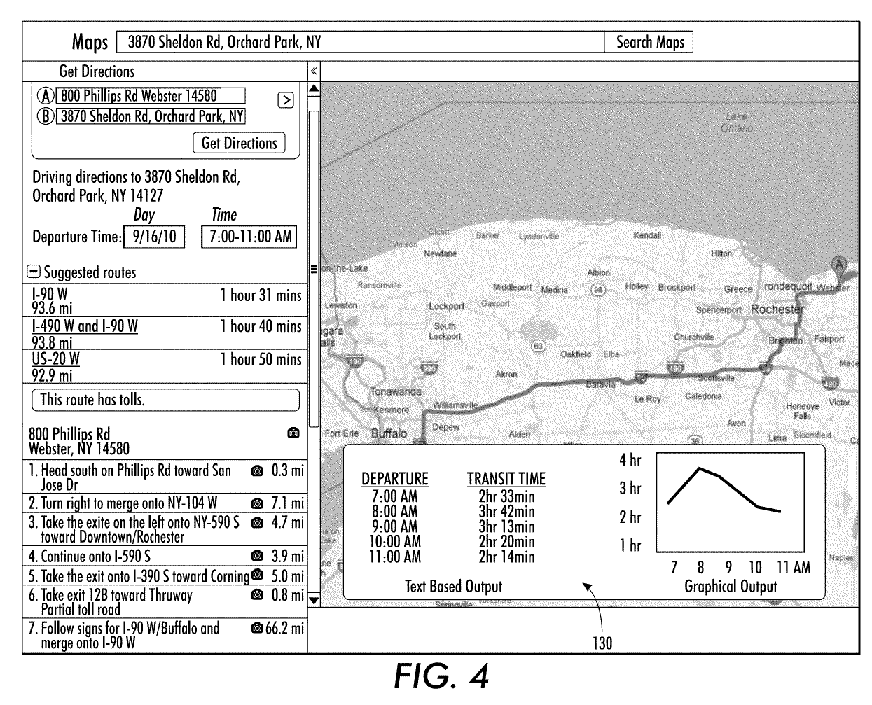

In addition, the user could request this type of information for a range of departure times or other parameters, and the systems and methods herein provide a graphical or chart based display of routes, times and other metrics. For example, as shown in FIG. 4, item 130 is a chart graphically illustrating how the transit time is lower before 8:00 AM and how transit time decreases after 8:00 AM. This type of information allows the user to select the departure time and route that optimized the metrics (preferences) that were most important to them (travel time, cost, etc). In this example the user inputs a range of departure times, prompting the system to display a range of transit times over the range of possible departure times. This graphical capability makes it easy to pick an optimal departure time to minimize overall travel time (in this case, 11:00 AM is best and 8:00 AM should be avoided).

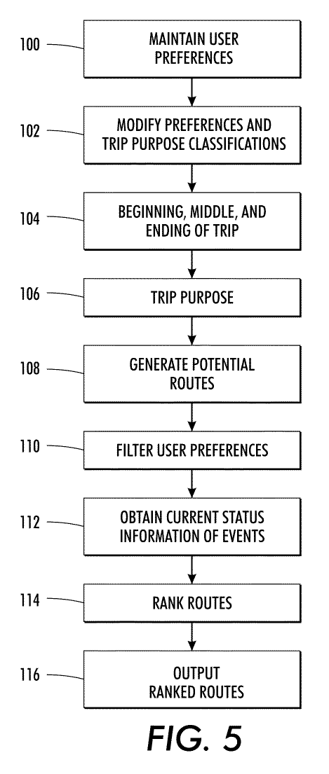

FIG. 5 is flowchart illustrating an exemplary method of providing route guidance herein. As shown in item 100, such methods maintain a plurality of user or default preferences within a non-volatile storage medium of at least one computerized device. As would be understood by those ordinarily skilled in the art, the data storage and processing performed by the devices described herein can be performed locally by a single local device, or can be performed partially or completely remotely from the local device using one or more remote devices connected (continuously or periodically) to the local device through various wired and wireless networks.

The user preferences can include (but are not limited to) for example: a preference regarding walking segments (which can be, for example, based on a weather forecast); a preference regarding amenities available at transfer stations; a preference regarding use of a specific fare payment method; a preference regarding use of stairs; a preference regarding traveling with a bicycle; a preference regarding rental of a car, bike or taxi; a preference regarding maximum number of transfers; a preference regarding a walking time and distance; a preference regarding carbon footprint; a preference regarding probability of seat availability; a preference regarding use of underground segments; a preference regarding risk on possible delays and cancellations; a preference regarding the desire to start and/or end the trip with a specific mode of transportation; etc.

The user preferences can be categorized into different pre-established trip purposes in the non-volatile storage medium. Therefore, as a simplified example, a “commute” purpose classification would minimize walking and stair climbing preferences (through elimination (or weighting) of those preferences), while a “vacation” or “work-break” purpose might equally balance walking and stair climbing with other modes of transportation. Similarly, a vacation purpose could include a preference to be routed toward street festivals, while a commuting purpose could include an exact opposite preference to be routed away from such street festivals. Modifications to the user preferences and pre-established trip purpose classifications can be received at many different times during the processing, as represented by in item 102.

The methods herein receive a beginning location, possible middle locations (intermediate stops along the trip), and an ending location of a trip in item 104 and a trip purpose of the trip into the computerized device(s) 106. The trip purpose can be selected from one of the pre-established trip purposes or input manually in item 106. Various keyword identification schemes are used to match free-form, natural language statements of purpose input by the user to any of the previously established trip purpose categories in item 106.

In item 108, the methods herein automatically generate multiple different potential routes between the beginning location and the ending location using the computerized device(s). At least two of the multiple different routes can utilize different transportation systems (different modes of transport including private car, public transportation, walking, biking, etc.) and at least two of the multiple different routes can comprise the same single identical route that departs at different departure times.

The methods herein then automatically filter the user preferences in some manner to make the preferences be more aligned with the selected trip purpose in item 110. For example in item 110, methods herein can receive additional user input (through the use of check-boxes, for example) regarding the specific preferences that are to be applied to any given trip. In another example, the methods herein can (additionally or alternatively) automatically create a subset of less than all of the user pre-established preferences that match the input trip purpose to produce purpose-specific preferences in item 110. Other methods represented by item 110 herein can (additionally or alternatively) change the weighting priority of less than all of the user preferences that match the trip purpose to produce purpose-specific weighted preferences.

As shown by item 112, these methods herein can further automatically obtain (using the computerized device(s)) current status information of events occurring along each of the multiple different routes. Such events can comprise weather, concerts, sporting events, parades, traffic, construction, crime reports, etc. Also, other methods herein can obtain and output targeted advertizing from the computerized device(s) based on the trip purpose and the user's current location (if such a device is location aware through such features as global positioning systems (GPS), etc.).

In item 114, these methods can automatically rank the multiple different routes by ranking routes that match more of the purpose-specific preferences ahead of routes that match less of the purpose-specific preferences (to produce a ranked order of the routes). Alternatively in item 114, such methods can automatically generate a unique score for each of the potential multiple different routes based on whether (or how closely) the multiple different routes match the potentially weighted, purpose-specific user preferences. Different weightings of the preferences would increase or decrease each potential routes score. Thus, certain ones of the multiple different routes that match the purpose-specific weighted preferences receive a higher scoring relative to other ones of the multiple different routes that do not match the purpose-specific weighted preferences. Therefore, these methods herein automatically rank the multiple different routes according to the scoring (or any other ranked order) using the computerized device(s) and automatically output the multiple different routes in the ranked order from the computerized device(s) in item 116. As would be understood by those ordinarily skilled in the art, these ranked routes could be output in item 116 as a text list, graphically overlaid on a map, shown in a table format, etc.

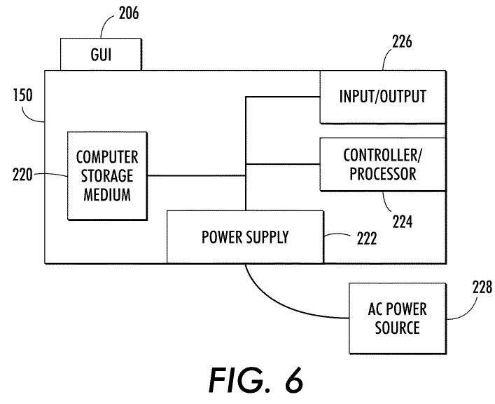

FIG. 6 illustrates a computerized device 150, which can be used with embodiments herein and can comprise, for example, personal computers, personal digital assistant (PDA) units, cell phones, global positioning system (GPS) units, etc. The computerized device 150 includes a controller/processor 224, and a communications port (input/output) 226 operatively connected to the processor 224 and to a computerized network external to the computerized device. Also, the computerized device 150 can include at least one accessory functional component such as a graphic user interface assembly 206 that also operate on the power supplied from the external power source 228 (through the power supply 222).

The input/output device 226 is used for communications to and from the computerized device 150and can be wired, wireless, etc. The processor 224controls the various actions of the computerized device. A non-transitory computer storage medium device 220 (which can be optical, magnetic, capacitor based, etc.) is readable by the processor 224 and stores instructions that the processor 224 executes to allow the computerized device to perform its various functions, such as those described herein.

Such a computerized device 150 can provide route guidance. The non-volatile storage medium 220 also maintains a plurality of user preferences. Further, the graphic user interface 206 receives the beginning location, the ending location, and the trip purpose. The processor 224 automatically generates multiple different routes between the beginning location and the ending location. The processor 224 also automatically filters the user preferences that match the trip purpose to produce purpose-specific preferences (or purpose-specific weighted preferences, as discussed above). The processor 224 automatically ranks the multiple different routes by ranking routes that match more of the purpose-specific (or weighted) preferences ahead of routes that match less of the preferences to produce a ranked order. Further, the graphic user interface 206 automatically outputs the multiple different routes in the ranked order.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A computer implemented method of providing route guidance comprising:
maintaining a plurality of user preferences within a non-volatile storage medium of at least one computerized device;
receiving a beginning location and an ending location of a trip into said at least one computerized device;
receiving a trip purpose of said trip into said at least one computerized device;
automatically generating multiple different routes between said beginning location and said ending location using said at least one computerized device;
automatically creating a subset of less than all of said user preferences that match said trip purpose to produce purpose-specific preferences using said at least one computerized device;
automatically ranking said multiple different routes by ranking routes that match more of said purpose-specific preferences ahead of routes that match less of said purpose-specific preferences to produce a ranked order, using said at least one computerized device; and
automatically outputting said multiple different routes in said ranked order from said at least one computerized device.

2. The method according to claim 1, further comprising automatically obtaining, using said at least one computerized device, current status information of events occurring along each of said multiple different routes, said events comprising at least one of weather, concerts, sporting events, and parades.

3. The method according to claim 1, further comprising outputting targeted advertizing from said at least one computerized device based on said trip purpose.

4. The method according to claim 1, said user preferences comprising at least one of:
a preference regarding walking segments based on a weather forecast;
a preference regarding amenities available at transfer stations;
a preference regarding use of a specific fare payment method;
a preference regarding use of stairs;
a preference regarding traveling with a bicycle;
a preference regarding rental of a car, bike and taxi;
a preference regarding maximum number of transfers;
a preference regarding a walking time and distance;
a preference regarding carbon footprint;
a preference regarding probability of seat availability;
a preference regarding use of underground segments;
a preference regarding risk on possible delays and cancellations; and
a preference regarding desire to start and end the trip with a specific mode of transportation.

5. The method according to claim 1, further comprising receiving modifications to said user preferences into said at least one computerized device.

6. A computer implemented method of providing route guidance comprising:
maintaining a plurality of user preferences within a non-volatile storage medium of at least one computerized device, said user preferences being categorized into different trip purposes;
receiving a beginning location and an ending location of a trip into said at least one computerized device;
receiving a trip purpose of said trip into said at least one computerized device, said trip purpose comprising one of said trip purposes;
automatically generating multiple different routes between said beginning location and said ending location using said at least one computerized device, at least two of said multiple different routes utilizing different transportation systems;
automatically creating a subset of less than all of said user preferences that match said trip purpose to produce purpose-specific preferences using said at least one computerized device;
automatically ranking said multiple different routes by ranking routes that match more of said purpose-specific preferences ahead of routes that match less of said purpose-specific preferences to produce a ranked order, using said at least one computerized device; and
automatically outputting said multiple different routes in said ranked order from said at least one computerized device.

7. The method according to claim 6, further comprising automatically obtaining, using said at least one computerized device, current status information of events occurring along each of said multiple different routes, said events comprising at least one of weather, concerts, sporting events, and parades.

8. The method according to claim 6, further comprising outputting targeted advertizing from said at least one computerized device based on said trip purpose.

9. The method according to claim 6, said user preferences comprising at least one of:
a preference regarding walking segments based on a weather forecast;
a preference regarding amenities available at transfer stations;
a preference regarding use of a specific fare payment method;
a preference regarding use of stairs;
a preference regarding traveling with a bicycle;
a preference regarding rental of a car, bike and taxi;
a preference regarding maximum number of transfers;
a preference regarding a walking time and distance;
a preference regarding carbon footprint;
a preference regarding probability of seat availability;
a preference regarding use of underground segments;
a preference regarding risk on possible delays and cancellations; and
a preference regarding desire to start and end the trip with a specific mode of transportation.

10. The method according to claim 6, further comprising receiving modifications to said user preferences into said at least one computerized device.

11. A computer implemented method of providing route guidance comprising:
maintaining a plurality of user preferences within a non-volatile storage medium of at least one computerized device, said user preferences being categorized into different trip purposes;
receiving a beginning location and an ending location of a trip into said at least one computerized device;
receiving a trip purpose of said trip into said at least one computerized device, said trip purpose comprising one of said different trip purposes;
automatically generating multiple different routes between said beginning location and said ending location using said at least one computerized device, at least two of said multiple different routes utilizing different transportation systems, at least two of said multiple different routes comprising a single identical route departing at different departure times;
automatically changing a weighting priority of less than all of said user preferences that match said trip purpose to produce purpose-specific weighted preferences using said at least one computerized device;
automatically scoring each of said multiple different routes based on whether said multiple different routes match said user preferences, ones of said multiple different routes that match said purpose-specific weighted preferences receiving a higher scoring relative to ones of said multiple different routes that do not match said purpose-specific weighted preferences;
automatically ranking said multiple different routes according to said scoring, using said at least one computerized device; and
automatically outputting said multiple different routes in said ranked order from said at least one computerized device.

12. The method according to claim 11, further comprising automatically obtaining, using said at least one computerized device, current status information of events occurring along each of said multiple different routes, said events comprising at least one of weather, concerts, sporting events, and parades.

13. The method according to claim 11, further comprising outputting targeted advertizing from said at least one computerized device based on said trip purpose.

14. The method according to claim 11, said user preferences comprising at least one of:
a preference regarding walking segments based on a weather forecast;
a preference regarding amenities available at transfer stations;
a preference regarding use of a specific fare payment method;
a preference regarding use of stairs;
a preference regarding traveling with a bicycle;
a preference regarding rental of a car, bike and taxi;
a preference regarding maximum number of transfers;
a preference regarding a walking time and distance;
a preference regarding carbon footprint;
a preference regarding probability of seat availability;
a preference regarding use of underground segments;
a preference regarding risk on possible delays and cancellations; and
a preference regarding desire to start and end the trip with a specific mode of transportation.

15. The method according to claim 11, further comprising receiving modifications to said user preferences into said at least one computerized device.

16. A computerized device providing route guidance comprising:
a processor;
a non-volatile storage medium operatively connected to said processor, said processor performing functions based on instructions stored in said non-volatile storage medium, and said non-volatile storage medium maintaining a plurality of user preferences; and
a graphic user interface operatively connected to said processor, said graphic user interface receiving a beginning location and an ending location of a trip into said at least one computerized device;
said graphic user interface receiving a trip purpose of said trip;
said processor automatically generating multiple different routes between said beginning location and said ending location;
said processor automatically creating a subset of less than all of said user preferences that match said trip purpose to produce purpose-specific preferences;
said processor automatically ranking said multiple different routes by ranking routes that match more of said purpose-specific preferences ahead of routes that match less of said purpose-specific preferences to produce a ranked order; and
said graphic user interface automatically outputting said multiple different routes in said ranked order.

17. The computerized device according to claim 16, said processor automatically obtaining current status information of events occurring along each of said multiple different routes, said events comprising at least one of weather, concerts, sporting events, and parades.

18. The computerized device according to claim 16, said graphic user interface outputting targeted advertizing based on said trip purpose.

19. The computerized device according to claim 16, said user preferences comprising at least one of:
a preference regarding walking segments based on a weather forecast;
a preference regarding amenities available at transfer stations;
a preference regarding use of a specific fare payment computerized device;
a preference regarding use of stairs;
a preference regarding traveling with a bicycle;
a preference regarding rental of a car, bike and taxi;
a preference regarding maximum number of transfers;
a preference regarding a walking time and distance;
a preference regarding carbon footprint;
a preference regarding probability of seat availability;
a preference regarding use of underground segments;
a preference regarding risk on possible delays and cancellations; and
a preference regarding desire to start and end the trip with a specific mode of transportation.

20. The computerized device according to claim 16, said graphic user interface receiving modifications to said user.
